(19) United States
(12) Patent Application Publication
(10) Pub. No.: US 2024/0049781 A1
(43) Pub. Date: Feb. 15, 2024

(54) AN AEROSOL-GENERATING SYSTEM COMPRISING A TRANSDUCER

(71) Applicant: Philip Morris Products S.A., Neuchatel (CH)

(72) Inventors: Sergey VERLINSKI, Yerevan (AM); Mikayel PILOYAN, Yerevan (AM)

(73) Assignee: Philip Morris Products S.A., Neuchatel (CH)

(21) Appl. No.: 18/258,252

(22) PCT Filed: Dec. 15, 2021
(86) PCT No.: PCT/EP2021/085948

§ 371 Date: Jun. 19, 2023

(30) Foreign Application Priority Data
Dec. 23, 2020 (AM) AM20200098

(51) Int. Cl. A24F 40/05; A24F 40/10; A24F 40/30; A24F 40/42

(52) U.S. Cl. CPC A24F 40/05; A24F 40/10; A24F 40/30; A24F 40/42

(57) ABSTRACT

An aerosol-generating system is provided, including: an aerosol-generator housing; and a piezoelectric transducer having an elliptical shape and including a first region and a second region, the second region being electrically isolated from the first region, and the piezoelectric transducer being secured to the aerosol-generator housing at a single attachment point positioned only within the first region.

The present disclosure relates to an aerosol-generating system. In particular, the present disclosure relates to an aerosol-generating system comprising a piezoelectric transducer having an elliptical shape and a first region electrically isolated from a second region.

One example of an aerosol-generating system is an e-cigarette. Typically, an e-cigarette comprises an electric heater arranged to generate an aerosol by heating and vaporising a liquid aerosol-forming substrate. Alternative designs have been proposed that use a vibrating transducer instead of a heater. The vibrating transducer is used to generate droplets from a liquid aerosol-forming substrate, wherein the droplets form an aerosol.

Some liquid aerosol-forming substrates may comprise a number of different components. For example, a liquid aerosol-forming substrate may comprise nicotine, water, and at least one aerosol former such as glycerin. However, when aerosolising a liquid aerosol-forming substrate using a vibrating transducer, optimum aerosolisation of the different components of the liquid aerosol-forming substrate may be achieved at different vibrational modes, frequencies, amplitudes, and so forth. Therefore, the particular mode of operation of the vibrating transducer is typically selected as a compromise such that the aerosolisation of the different components of the liquid aerosol-forming substrate is not optimised.

It would be desirable to provide an aerosol-generating system that overcomes the above problems with known aerosol-generating systems.

According to the present disclosure there is provided an aerosol-generating system comprising an aerosol-generator housing and a piezoelectric transducer. The piezoelectric transducer has an elliptical shape and comprises a first region and a second region, wherein the second region is electrically isolated from the first region. The piezoelectric transducer is secured to the aerosol-generator housing at a single attachment point positioned only within the first region.

Advantageously, providing the piezoelectric transducer with first and second regions that are electrically isolated from each other facilitates separate activation of the first and second regions. Advantageously, the first region may be activated with at least one of a first vibrational mode, frequency, and amplitude that is optimised for aerosolisation of a first liquid. Advantageously, the second region may be activated with at least one of a different vibrational model, frequency and amplitude that is optimised for aerosolisation of a second liquid that is different to the first liquid.

Advantageously, providing the piezoelectric transducer with first and second regions that are electrically isolated from each other facilitates optimised aerosolisation of different liquids without requiring multiple different piezoelectric transducers. Advantageously, providing a single piezoelectric transducers that facilitates optimised aerosolisation of different liquids may reduce or minimise the complexity of the aerosol-generating system.

Advantageously, providing the piezoelectric transducer with an elliptical shape may facilitate providing each of the first and second regions with a shape that facilitates optimised aerosolisation of a liquid substrate. For example, the elliptical shape may facilitate providing the first region and the second region with different sizes according to an amount of liquid to be aerosolised by each of the first region and second region.

Advantageously, securing the piezoelectric transducer to the aerosol-generator housing at a single attachment point positioned only within the first region facilitates activation of the first region and the second region with different vibrational modes. For example, securing the first region to the aerosol-generator housing may constrain the first region to a planar vibrational mode. Providing the piezoelectric transducer with a second region that is not secured to the aerosol-generating housing may facilitate vibration of the second region with a bending vibrational mode. Advantageously, the different vibrational modes may be optimised for the aerosolisation of different liquids.

The attachment point may be positioned at a centre of the elliptical piezoelectric transducer. Advantageously, positioning the attachment point at the centre of the transducer may facilitate positioning of the transducer within the aerosol-generator housing during assembly of the aerosol-generating system.

The attachment point may be positioned at a centre of the first region. Advantageously, positioning the attachment point at the centre of the first region may facilitate activation of the first region with a planar vibrational mode.

The second region may extend between the first region and an edge of the piezoelectric transducer. Advantageously, providing a second region that extends between the first region and an edge of the piezoelectric transducer may facilitate activation of the second region with a bending vibrational mode.

The piezoelectric transducer may comprise a first groove in a surface of the piezoelectric transducer and an electrically insulating material positioned within the first groove, wherein the first groove defines a boundary between the first region and the second region. Advantageously, providing an electrically insulating material within a first groove to electrically isolate the second region from the first region may reduce or minimise the complexity of forming the piezoelectric transducer. For example, in a first step the transducer may be formed to a desired size and shape from a piezoelectric material. In a subsequent step, the first and second regions may be formed by creating the first groove in the piezoelectric material and positioning the electrically insulating material within the first groove.

The electrically insulating material may comprise at least one of glass, asbestos, varnish, resin, paper, silicone, and rubber. Suitable rubbers include natural rubber and synthetic rubbers.

The piezoelectric transducer may comprise one or more additional regions, wherein the one or more additional regions are electrically isolated from each other and wherein the one or more additional regions are electrically isolated from each of the first region and the second region. Advantageously, the one or more additional regions may be activated with one or more of a different vibrational mode, frequency, and amplitude that is optimised for aerosolisation of one or more additional liquids.

The piezoelectric transducer may comprise a third region, wherein the third region is electrically isolated from each of the first region and the second region.

The piezoelectric transducer may comprises a second groove in a surface of the piezoelectric transducer and an electrically insulating material positioned within the second groove, wherein the second groove defines a boundary between the first region and the third region. The electrically insulating material may comprise any of the suitable electrically insulating materials described herein.

The third region may extend between the first region and an edge of the piezoelectric transducer.

The piezoelectric transducer may comprise a fourth region, wherein the fourth region is electrically isolated from each of the first region, the second region and the third region.

The piezoelectric transducer may comprise a third groove in a surface of the piezoelectric transducer and an electrically insulating material positioned within the third groove, wherein the third groove defines a boundary between the first region and the fourth region. The electrically insulating material may comprise any of the suitable electrically insulating materials described herein.

The fourth region may extend between the first region and an edge of the piezoelectric transducer.

The piezoelectric transducer may comprise a fifth region, wherein the fifth region is electrically isolated from each of the first region, the second region, the third region and the fourth region.

The piezoelectric transducer may comprise a fourth groove in a surface of the piezoelectric transducer and an electrically insulating material positioned within the fourth groove, wherein the fourth groove defines a boundary between the first region and the fifth region. The electrically insulating material may comprise any of the suitable electrically insulating materials described herein.

The fifth region may extend between the first region and an edge of the piezoelectric transducer.

The first region may have a symmetrical shape.

The first region may have a rhombus shape. Advantageously, the rhombus shape of the first region may facilitate the second, third, fourth and fifth regions having at least one of the same size and shape.

Preferably, the rhombus shape has four vertices, wherein each of the vertices is positioned at an edge of the piezoelectric transducer. Advantageously, positioning the vertices of the rhombus shape of the first region at the edge of the piezoelectric transducer may electrically isolate the second, third, fourth and fifth regions from each other without requiring additional grooves or electrically insulating material.

The piezoelectric transducer may comprise a first layer of piezoelectric material and a second layer of piezoelectric material, wherein the first layer overlies the second layer. Advantageously, forming the piezoelectric transducer from two layers of piezoelectric material may facilitate activation of the first and second regions with one or more of a different vibrational mode, frequency, and amplitude.

Preferably, the first layer of piezoelectric material is polarised in a first direction and the second layer of piezoelectric material is polarised in a second direction, wherein the first direction is opposite to the second direction. Advantageously, providing the first and second layers of piezoelectric material with opposite polarisations may facilitate activation of at least the second region with a bending vibrational mode.

Preferably, the first layer of piezoelectric material has a planar shape and the first direction is orthogonal to the planar shape of the first layer of piezoelectric material. Preferably, the second layer of piezoelectric material has a planar shape and the second direction is orthogonal to the planar shape of the second layer of piezoelectric material.

Preferably, a surface of the first layer of piezoelectric material forms a first surface of the piezoelectric transducer. Preferably, a surface of the second layer of piezoelectric material forms a second surface of the piezoelectric transducer opposite the first surface.

Preferably, the first layer of piezoelectric material contacts the second layer of piezoelectric material at an interface between the first layer of piezoelectric material and the second layer of piezoelectric material.

The piezoelectric transducer may comprise a monocrystalline material. The piezoelectric transducer may comprise quartz. The piezoelectric transducer may comprise a ceramic. The ceramic may comprise barium titanate (BaTiO3). The ceramic may comprise lead zirconate titanate (PZT). The ceramic may include doping materials such as Ni, Bi, La, Nd or Nb ions. In embodiments in which the piezoelectric transducer comprises a first layer of piezoelectric material and a second layer of piezoelectric material, the first layer and the second layer may comprise the same material or different materials.

Preferably, the aerosol-generating system further comprises a power supply and a controller configured to supply power from the power supply to the piezoelectric transducer.

The power supply comprise a battery. The battery may be a Lithium based battery, for example a Lithium-Cobalt, a Lithium-Iron-Phosphate, a Lithium Titanate or a Lithium-Polymer battery. The battery may be a Nickel-metal hydride battery or a Nickel cadmium battery. The power supply may be another form of charge storage device such as a capacitor. The power supply may be rechargeable and be configured for many cycles of charge and discharge. The power supply may have a capacity that allows for the storage of enough energy for one or more user experiences; for example, the power supply may have sufficient capacity to allow for the continuous generation of aerosol for a period of about six minutes, corresponding to the typical time taken to smoke a conventional cigarette, or for a period that is a multiple of six minutes. In another example, the power supply may have sufficient capacity to allow for a predetermined number of puffs or discrete activations of the piezoelectric transducer.

The controller may comprise a microprocessor. The microprocessor may be a programmable microprocessor, a microcontroller, or an application specific integrated chip (ASIC) or other electronic circuitry capable of providing control. The controller may comprise further electronic components. For example, in some embodiments, the controller may comprise any of:

sensors, switches, display elements. Power may be supplied to the piezoelectric transducer continuously following activation of the aerosol-generating device or may be supplied intermittently, such as on a puff-by-puff basis. The power may be supplied to the piezoelectric transducer in the form of pulses of electrical current, for example, by means of pulse width modulation (PWM).

The controller may be configured to supply power to the piezoelectric transducer to generate a first oscillating potential difference in the first region between the first surface of the piezoelectric transducer and the second surface of the piezoelectric transducer. Advantageously, generating an oscillating potential difference in the first region between the first and second surfaces of the piezoelectric transducer may facilitate activation of the first region with a planar vibrational mode. The controller may comprise drive circuitry electrically connected to the piezoelectric transducer in the first region at the first surface and the second surface, wherein the controller is configured to generate the first oscillating potential difference via the drive circuitry.

The controller may be configured to supply power to the piezoelectric transducer to generate a second oscillating potential difference in the second region between the first surface of the piezoelectric transducer and the interface between the first layer of piezoelectric material and the second layer of piezoelectric material. Advantageously, generating an oscillating potential difference in the second region between the first surface and the interface may facilitate activation of the second region with a bending vibrational mode. The controller may comprise drive circuitry electrically connected to the piezoelectric transducer in the second region at the first surface and the interface, wherein the controller is configured to generate the second oscillating potential difference via the drive circuitry.

The controller may be configured to supply power to the piezoelectric transducer to generate a third oscillating potential difference in the second region between the second surface of the piezoelectric transducer and the interface between the first layer of piezoelectric material and the second layer of piezoelectric material. Advantageously, generating an oscillating potential difference in the second region between the second surface and the interface may facilitate activation of the second region with a bending vibrational mode. The controller may comprise drive circuitry electrically connected to the piezoelectric transducer in the second region at the second surface and the interface, wherein the controller is configured to generate the third oscillating potential difference via the drive circuitry.

Preferably, the controller is configured to supply power to the piezoelectric transducer to generate both the second oscillating potential difference and the third oscillating potential difference. Advantageously, simultaneously generating both the second and third oscillating potential differences may increase or maximise an amplitude of the bending vibrational mode of the second region. Preferably, the second oscillating potential difference is the same as the third oscillating potential difference. Preferably, the second oscillating potential difference is in phase with the third oscillating potential difference.

The controller may be configured to supply power to the piezoelectric transducer to generate a fourth oscillating potential difference in the third region between the first surface of the piezoelectric transducer and the interface between the first layer of piezoelectric material and the second layer of piezoelectric material. Advantageously, generating an oscillating potential difference in the third region between the first surface and the interface may facilitate activation of the third region with a bending vibrational mode. The controller may comprise drive circuitry electrically connected to the piezoelectric transducer in the third region at the first surface and the interface, wherein the controller is configured to generate the fourth oscillating potential difference via the drive circuitry.

The controller may be configured to supply power to the piezoelectric transducer to generate a fifth oscillating potential difference in the third region between the second surface of the piezoelectric transducer and the interface between the first layer of piezoelectric material and the second layer of piezoelectric material. Advantageously, generating an oscillating potential difference in the third region between the second surface and the interface may facilitate activation of the third region with a bending vibrational mode. The controller may comprise drive circuitry electrically connected to the piezoelectric transducer in the third region at the second surface and the interface, wherein the controller is configured to generate the fifth oscillating potential difference via the drive circuitry.

Preferably, the controller is configured to supply power to the piezoelectric transducer to generate both the fourth oscillating potential difference and the fifth oscillating potential difference. Advantageously, simultaneously generating both the fourth and fifth oscillating potential differences may increase or maximise an amplitude of the bending vibrational mode of the third region. Preferably, the fourth oscillating potential difference is the same as the fifth oscillating potential difference. Preferably, the fourth oscillating potential difference is in phase with the fifth oscillating potential difference.

The controller may be configured to supply power to the piezoelectric transducer to generate a sixth oscillating potential difference in the fourth region between the first surface of the piezoelectric transducer and the interface between the first layer of piezoelectric material and the second layer of piezoelectric material. Advantageously, generating an oscillating potential difference in the fourth region between the first surface and the interface may facilitate activation of the fourth region with a bending vibrational mode. The controller may comprise drive circuitry electrically connected to the piezoelectric transducer in the fourth region at the first surface and the interface, wherein the controller is configured to generate the sixth oscillating potential difference via the drive circuitry.

The controller may be configured to supply power to the piezoelectric transducer to generate a seventh oscillating potential difference in the fourth region between the second surface of the piezoelectric transducer and the interface between the first layer of piezoelectric material and the second layer of piezoelectric material. Advantageously, generating an oscillating potential difference in the fourth region between the second surface and the interface may facilitate activation of the fourth region with a bending vibrational mode. The controller may comprise drive circuitry electrically connected to the piezoelectric transducer in the fourth region at the second surface and the interface, wherein the controller is configured to generate the seventh oscillating potential difference via the drive circuitry.

Preferably, the controller is configured to supply power to the piezoelectric transducer to generate both the sixth oscillating potential difference and the seventh oscillating potential difference. Advantageously, simultaneously generating both the sixth and seventh oscillating potential differences may increase or maximise an amplitude of the bending vibrational mode of the fourth region. Preferably, the sixth oscillating potential difference is the same as the seventh oscillating potential difference. Preferably, the sixth oscillating potential difference is in phase with the seventh oscillating potential difference.

The controller may be configured to supply power to the piezoelectric transducer to generate an eighth oscillating potential difference in the fifth region between the first surface of the piezoelectric transducer and the interface between the first layer of piezoelectric material and the second layer of piezoelectric material. Advantageously, generating an oscillating potential difference in the fifth region between the first surface and the interface may facilitate activation of the fifth region with a bending vibrational mode. The controller may comprise drive circuitry electrically connected to the piezoelectric transducer in the fifth region at the first surface and the interface, wherein the controller is configured to generate the eighth oscillating potential difference via the drive circuitry.

The controller may be configured to supply power to the piezoelectric transducer to generate a ninth oscillating potential difference in the fifth region between the second surface of the piezoelectric transducer and the interface between the first layer of piezoelectric material and the second layer of piezoelectric material. Advantageously, generating an oscillating potential difference in the fifth region between the second surface and the interface may facilitate activation of the fifth region with a bending vibrational mode. The controller may comprise drive circuitry electrically connected to the piezoelectric transducer in the fifth region at the second surface and the interface, wherein the controller is configured to generate the ninth oscillating potential difference via the drive circuitry.

Preferably, the controller is configured to supply power to the piezoelectric transducer to generate both the eighth oscillating potential difference and the ninth oscillating potential difference. Advantageously, simultaneously generating both the eighth and ninth oscillating potential differences may increase or maximise an amplitude of the bending vibrational mode of the fifth region. Preferably, the eighth oscillating potential difference is the same as the ninth oscillating potential difference. Preferably, the eighth oscillating potential difference is in phase with the ninth oscillating potential difference.

Each oscillating potential difference may comprise a waveform having a sinusoidal shape, a square-wave shape, a triangular-wave shape, or a sawtooth-wave shape.

Each oscillating potential difference may have a frequency of between about 20 kHz and about 1500 kHz, or between about 50 kHz and about 1000 kHz, or between about 100 kHz and about 500 kHz. Oscillating potential differences having a frequency within one of these ranges may provide at least one of a desired aerosol-output rate and a desired aerosol droplet size.

The controller may be configured to supply power to each region of the piezoelectric transducer simultaneously. The controller may be configured to supply power independently to each region of the piezoelectric transducer.

The aerosol-generating system may comprise a first liquid storage compartment in fluid communication with the first region of the piezoelectric transducer. The aerosol-generating system may comprise a first liquid aerosol-forming substrate contained within the first liquid storage compartment. Preferably, the aerosol-generating system is configured to supply first liquid aerosol-forming substrate from the first liquid storage compartment to the first region of the piezoelectric transducer. The first liquid aerosol-forming substrate may comprise at least one of nicotine, glycerin, polyethylene glycol, and an acid.

The aerosol-generating system may comprise a second liquid storage compartment in fluid communication with the second region of the piezoelectric transducer. The aerosol-generating system may comprise a second liquid aerosol-forming substrate contained within the second liquid storage compartment. Preferably, the aerosol-generating system is configured to supply second liquid aerosol-forming substrate from the second liquid storage compartment to the second region of the piezoelectric transducer. The second liquid aerosol-forming substrate may comprise at least one of nicotine, glycerin, polyethylene glycol, and an acid.

The aerosol-generating system may comprise a third liquid storage compartment in fluid communication with the third region of the piezoelectric transducer. The aerosol-generating system may comprise a third liquid aerosol-forming substrate contained within the third liquid storage compartment. Preferably, the aerosol-generating system is configured to supply third liquid aerosol-forming substrate from the third liquid storage compartment to the third region of the piezoelectric transducer. The third liquid aerosol-forming substrate may comprise at least one of nicotine, glycerin, polyethylene glycol, and an acid.

The aerosol-generating system may comprise a fourth liquid storage compartment in fluid communication with the fourth region of the piezoelectric transducer. The aerosol-generating system may comprise a fourth liquid aerosol-forming substrate contained within the fourth liquid storage compartment. Preferably, the aerosol-generating system is configured to supply fourth liquid aerosol-forming substrate from the fourth liquid storage compartment to the fourth region of the piezoelectric transducer. The fourth liquid aerosol-forming substrate may comprise at least one of nicotine, glycerin, polyethylene glycol, and an acid.

The aerosol-generating system may comprise a fifth liquid storage compartment in fluid communication with the fifth region of the piezoelectric transducer. The aerosol-generating system may comprise a fifth liquid aerosol-forming substrate contained within the fifth liquid storage compartment. Preferably, the aerosol-generating system is configured to supply fifth liquid aerosol-forming substrate from the fifth liquid storage compartment to the fifth region of the piezoelectric transducer. The fifth liquid aerosol-forming substrate may comprise at least one of nicotine, glycerin, polyethylene glycol, and an acid.

At least one of the liquid storage compartments may form part of a cartridge that is separable from the remainder of the aerosol-generating system. The remainder of the aerosol-generating system may be an aerosol-generating device configured to be removably coupled with the cartridge. Preferably, the aerosol-generating device comprises the aerosol-generator housing, the piezoelectric transducer, the power supply and the controller. The aerosol-generating device may comprise a device housing, wherein the aerosol-generator housing, the piezoelectric transducer, the power supply and the controller are at least partially received within the device housing. The device housing may be continuous with the aerosol-generator housing. At least part of the aerosol-generator housing may be formed by the device housing.

At least one of the liquid storage compartments may comprise a carrier material for holding the respective liquid aerosol-forming substrate. The carrier material may be made from any suitable absorbent plug or body, for example, a foamed metal or plastics material, polypropylene, terylene, nylon fibres or ceramic.

The aerosol-generating system may comprise at least one capillary material arranged to convey at least one of the liquid aerosol-forming substrates to the piezoelectric transducer. The aerosol-generating system may comprise a first capillary material arranged to convey the first liquid aerosol-forming substrate from the first liquid storage compartment to the first region of the piezoelectric transducer. The aerosol-generating system may comprise a second capillary material arranged to convey the second liquid aerosol-forming substrate from the second liquid storage compartment to the second region of the piezoelectric transducer. The aerosol-generating system may comprise a third capillary material arranged to convey the third liquid aerosol-forming substrate from the third liquid storage compartment to the third region of the piezoelectric transducer. The aerosol-generating system may comprise a fourth capillary material arranged to convey the fourth liquid aerosol-forming substrate from the fourth liquid storage compartment to the fourth region of the piezoelectric transducer. The aerosol-generating system may comprise a fifth capillary material arranged to convey the fifth liquid aerosol-forming substrate from the fifth liquid storage compartment to the fifth region of the piezoelectric transducer.

In embodiments in which at least one of the liquid storage compartments comprises a carrier material, the carrier material may comprise the capillary material.

The capillary material may have a fibrous structure. The capillary material may have a spongy structure. The capillary material may comprise a bundle of capillaries. The capillary material may comprise a plurality of fibres. The capillary material may comprise a plurality of threads. The capillary material may comprise fine bore tubes. The capillary material may comprise a combination of fibres, threads and fine-bore tubes. The fibres, threads and fine-bore tubes may be generally aligned to convey liquid aerosol-forming substrate to the piezoelectric transducer. The capillary material may comprise sponge-like material. The capillary material may comprise foam-like material. The structure of the capillary material may form a plurality of small bores or tubes, through which the liquid aerosol-forming substrate can be transported by capillary action.

The capillary material may comprise any suitable material or combination of materials. Examples of suitable materials are a sponge or foam material, ceramic- or graphite-based materials in the form of fibres or sintered powders, foamed metal or plastics materials, a fibrous material, for example made of spun or extruded fibres, such as cellulose acetate, polyester, or bonded polyolefin, polyethylene, terylene or polypropylene fibres, nylon fibres or ceramic.

The aerosol-generating system may comprise at least one pump arranged to convey at least one of the liquid aerosol-forming substrates to the piezoelectric transducer. The aerosol-generating system may comprise a first pump arranged to convey the first liquid aerosol-forming substrate from the first liquid storage compartment to the first region of the piezoelectric transducer. The aerosol-generating system may comprise a second pump arranged to convey the second liquid aerosol-forming substrate from the second liquid storage compartment to the second region of the piezoelectric transducer. The aerosol-generating system may comprise a third pump arranged to convey the third liquid aerosol-forming substrate from the third liquid storage compartment to the third region of the piezoelectric transducer. The aerosol-generating system may comprise a fourth pump arranged to convey the fourth liquid aerosol-forming substrate from the fourth liquid storage compartment to the fourth region of the piezoelectric transducer. The aerosol-generating system may comprise a fifth pump arranged to convey the fifth liquid aerosol-forming substrate from the fifth liquid storage compartment to the fifth region of the piezoelectric transducer.

The pump may comprise at least one of a valve and a micropump. In embodiments in which the aerosol-generating system comprises a controller, preferably the controller is configured to control the at least one pump to control delivery of the respective liquid aerosol-forming substrate to the piezoelectric transducer.

In embodiments in which the aerosol-generating system comprises a liquid aerosol-forming substrate comprising nicotine, preferably the controller is configured to generate an oscillating potential difference having a frequency of about 121 kilohertz at a region of the piezoelectric transducer in fluid communication with the liquid aerosol-forming substrate comprising nicotine. The liquid aerosol-forming substrate may comprise at least one of the first to fifth liquid aerosol-forming substrates described herein. The region of the piezoelectric transducer may comprise at least one of the first to fifth regions described herein. The oscillating potential difference may comprise at least one of the first to ninth oscillating potential differences described herein.

In embodiments in which the aerosol-generating system comprises a liquid aerosol-forming substrate comprising glycerin, preferably the controller is configured to generate an oscillating potential difference having a frequency of about 123 kilohertz at a region of the piezoelectric transducer in fluid communication with the liquid aerosol-forming substrate comprising glycerin. The liquid aerosol-forming substrate may comprise at least one of the first to fifth liquid aerosol-forming substrates described herein. The region of the piezoelectric transducer may comprise at least one of the first to fifth regions described herein. The oscillating potential difference may comprise at least one of the first to ninth oscillating potential differences described herein.

In embodiments in which the aerosol-generating system comprises a liquid aerosol-forming substrate comprising an acid, preferably the controller is configured to generate an oscillating potential difference having a frequency of about 122.4 kilohertz at a region of the piezoelectric transducer in fluid communication with the liquid aerosol-forming substrate comprising the acid. The liquid aerosol-forming substrate may comprise at least one of the first to fifth liquid aerosol-forming substrates described herein. The region of the piezoelectric transducer may comprise at least one of the first to fifth regions described herein. The oscillating potential difference may comprise at least one of the first to ninth oscillating potential differences described herein.

In embodiments in which the aerosol-generating system comprises a liquid aerosol-forming substrate comprising nicotine, the nicotine containing liquid aerosol-forming substrate may be a nicotine salt matrix. The liquid aerosol-forming substrate may comprise plant-based material. The liquid aerosol-forming substrate may comprise tobacco. The liquid aerosol-forming substrate may comprise a tobacco-containing material containing volatile tobacco flavour compounds, which are released from the aerosol-forming substrate upon heating. The liquid aerosol-forming substrate may comprise homogenised tobacco material. The liquid aerosol-forming substrate may comprise a non-tobacco-containing material. The liquid aerosol-forming substrate may comprise homogenised plant-based material.

Preferably, the aerosol-generating system is portable. The aerosol-generating system may have a size comparable to a conventional cigar or cigarette. The aerosol-generating system may have a total length of between about 30 millimetres and about 150 millimetres. The aerosol-generating system may have an external diameter of between about 5 millimetres and about 30 millimetres.

The aerosol-generator housing and the device housing may comprise any suitable material or combination of materials. Examples of suitable materials include metals, alloys, plastics or composite materials containing one or more of those materials, or thermoplastics that are suitable for food or pharmaceutical applications, for example polypropylene, polyetheretherketone (PEEK) and polyethylene. The material may be light and non-brittle.

Preferably, the aerosol-generating system comprises an airflow inlet, an airflow outlet, and an airflow pathway extending between the airflow inlet and the airflow outlet. Preferably, at least part of the piezoelectric transducer is in fluid communication with the airflow pathway. Preferably, the airflow pathway is arranged to receive aerosolised liquid aerosol-forming substrate from the piezoelectric transducer.

The aerosol-generating system may comprise a mouthpiece. In embodiments in which the aerosol-generating system comprises an airflow outlet, preferably the mouthpiece comprises the airflow outlet. In embodiments in which the aerosol-generating system comprises an aerosol-generating device and a cartridge, the mouthpiece may form part of the aerosol-generating device or part of the cartridge. The mouthpiece may be configured for removable attachment to the aerosol-generating device or the cartridge.

The invention is defined in the claims. However, below there is provided a non-exhaustive list of non-limiting examples. Any one or more of the features of these examples may be combined with any one or more features of another example, embodiment, or aspect described herein.

Example Ex1: An aerosol-generating system comprising:
an aerosol-generator housing; and
a piezoelectric transducer having an elliptical shape and comprising a first region and a second region, wherein the second region is electrically isolated from the first region;
wherein the piezoelectric transducer is secured to the aerosol-generator housing at a single attachment point positioned only within the first region.

Example Ex2: An aerosol-generating system according to Example Ex1, wherein the attachment point is positioned at a centre of the elliptical piezoelectric transducer.

Example Ex3: An aerosol-generating system according to Example Ex1 or Ex2, wherein the second region extends between the first region and an edge of the piezoelectric transducer.

Example Ex4: An aerosol-generating system according to Example Ex1, Ex2 or Ex3, wherein the piezoelectric transducer comprises a first groove in a surface of the piezoelectric transducer and an electrically insulating material positioned within the first groove, wherein the first groove defines a boundary between the first region and the second region.

Example Ex5: An aerosol-generating system according to any preceding Example, wherein the piezoelectric transducer comprises a third region, and wherein the third region is electrically isolated from each of the first region and the second region.

Example Ex6: An aerosol-generating system according to Example Ex5, wherein the piezoelectric transducer comprises a second groove in a surface of the piezoelectric transducer and an electrically insulating material positioned within the second groove, wherein the second groove defines a boundary between the first region and the third region.

Example Ex7: An aerosol-generating system according to Example Ex5 or Ex6, wherein the third region extends between the first region and an edge of the piezoelectric transducer.

Example Ex8: An aerosol-generating system according to Example Ex5, Ex6 or Ex7, wherein the piezoelectric transducer comprises a fourth region, and wherein the fourth region is electrically isolated from each of the first region, the second region and the third region.

Example Ex9: An aerosol-generating system according to Example Ex8, wherein the piezoelectric transducer comprises a third groove in a surface of the piezoelectric transducer and an electrically insulating material positioned within the third groove, wherein the third groove defines a boundary between the first region and the fourth region.

Example Ex10: An aerosol-generating system according to Example Ex8 or Ex9, wherein the fourth region extends between the first region and an edge of the piezoelectric transducer.

Example Ex11: An aerosol-generating system according to Example Ex8, Ex9 or Ex10, wherein the piezoelectric transducer comprises a fifth region, and wherein the fifth region is electrically isolated from each of the first region, the second region, the third region and the fourth region.

Example Ex12: An aerosol-generating system according to Example Ex11, wherein the piezoelectric transducer comprises a fourth groove in a surface of the piezoelectric transducer and an electrically insulating material positioned within the fourth groove, wherein the fourth groove defines a boundary between the first region and the fifth region.

Example Ex13: An aerosol-generating system according to Example Ex11 or Ex12, wherein the fifth region extends between the first region and an edge of the piezoelectric transducer.

Example Ex14: An aerosol-generating system according to Example Ex11, Ex12 or Ex13, wherein the first region has a rhombus shape.

Example Ex15: An aerosol-generating system according to any preceding Example, wherein the piezoelectric transducer comprises a first layer of piezoelectric material and a second layer of piezoelectric material, and wherein the first layer overlies the second layer.

Example Ex16: An aerosol-generating system according to Example Ex15, wherein the first layer of piezoelectric material is polarised in a first direction, wherein the second layer of piezoelectric material is polarised in a second direction, and wherein the first direction is opposite to the second direction.

Example Ex17: An aerosol-generating system according to Example Ex16, wherein the first layer of piezoelectric material has a planar shape and wherein the first direction is orthogonal to the planar shape of the first layer of piezoelectric material.

Example Ex18: An aerosol-generating system according to Example Ex16 or Ex17, wherein the second layer of piezoelectric material has a planar shape and wherein the second direction is orthogonal to the planar shape of the second layer of piezoelectric material.

Example Ex19: An aerosol-generating system according to Example Ex15, Ex16, Ex17 or Ex18, wherein a surface of the first layer of piezoelectric material forms a first surface of the piezoelectric transducer, wherein a surface of the second layer of piezoelectric material forms a second surface of the piezoelectric transducer opposite the first surface, and wherein the first layer of piezoelectric material contacts the second layer of piezoelectric material at an interface between the first layer of piezoelectric material and the second layer of piezoelectric material.

Example Ex20: An aerosol-generating system according to any preceding Example, further comprising:
a power supply; and
a controller configured to supply power from the power supply to the piezoelectric transducer.

Example Ex21: An aerosol-generating system according to Examples Ex19 and Ex20, wherein the controller is configured to supply power to the piezoelectric transducer to generate a first oscillating potential difference in the first region between the first surface of the piezoelectric transducer and the second surface of the piezoelectric transducer.

Example Ex22: An aerosol-generating system according to Example Ex21, wherein the controller is configured to supply power to the piezoelectric transducer to generate a second oscillating potential difference in the second region between the first surface of the piezoelectric transducer and the interface between the first layer of piezoelectric material and the second layer of piezoelectric material.

Example Ex23: An aerosol-generating system according to Example Ex22, wherein the controller is configured to supply power to the piezoelectric transducer to generate a third oscillating potential difference in the second region between the second surface of the piezoelectric transducer and the interface between the first layer of piezoelectric material and the second layer of piezoelectric material.

Example Ex24: An aerosol-generating system according to Example Ex23 and Example Ex5, Ex6 or Ex7, wherein the controller is configured to supply power to the piezoelectric transducer to generate a fourth oscillating potential difference in the third region between the first surface of the piezoelectric transducer and the interface between the first layer of piezoelectric material and the second layer of piezoelectric material.

Example Ex25: An aerosol-generating system according to Example Ex24, wherein the controller is configured to supply power to the piezoelectric transducer to generate a fifth oscillating potential difference in the third region between the second surface of the piezoelectric transducer and the interface between the first layer of piezoelectric material and the second layer of piezoelectric material.

Example Ex26: An aerosol-generating system according to Example Ex24 or Ex25 in combination with Example Ex8, Ex9 or Ex10, wherein the controller is configured to supply power to the piezoelectric transducer to generate a sixth oscillating potential difference in the fourth region between the first surface of the piezoelectric transducer and the interface between the first layer of piezoelectric material and the second layer of piezoelectric material.

Example Ex27: An aerosol-generating system according to Example Ex26, wherein the controller is configured to supply power to the piezoelectric transducer to generate a seventh oscillating potential difference in the fourth region between the second surface of the piezoelectric transducer and the interface between the first layer of piezoelectric material and the second layer of piezoelectric material.

Example Ex28: An aerosol-generating system according to Example Ex26 or Ex27 in combination with Example Ex11, Ex12 or Ex13, wherein the controller is configured to supply power to the piezoelectric transducer to generate an eighth oscillating potential difference in the fifth region between the first surface of the piezoelectric transducer and the interface between the first layer of piezoelectric material and the second layer of piezoelectric material.

Example Ex29: An aerosol-generating system according to Example Ex28, wherein the controller is configured to supply power to the piezoelectric transducer to generate a ninth oscillating potential difference in the fifth region between the second surface of the piezoelectric transducer and the interface between the first layer of piezoelectric material and the second layer of piezoelectric material.

Example Ex30: An aerosol-generating system according to any preceding Example, further comprising a first liquid storage compartment in fluid communication with the first region of the piezoelectric transducer.

Example Ex31: An aerosol-generating system according to Example Ex30, further comprising a first liquid aerosol-forming substrate contained within the first liquid storage compartment.

Example Ex32: An aerosol-generating system according to Example Ex31, wherein the first liquid aerosol-forming substrate comprises at least one of nicotine, glycerin, polyethylene glycol, and an acid.

Example Ex33: An aerosol-generating system according to Example Ex30, Ex31 or Ex32, further comprising a second liquid storage compartment in fluid communication with the second region of the piezoelectric transducer.

Example Ex34: An aerosol-generating system according to Example Ex33, further comprising a second liquid aerosol-forming substrate contained within the second liquid storage compartment.

Example Ex35: An aerosol-generating system according to Example Ex34, wherein the second liquid aerosol-forming substrate comprises at least one of nicotine, glycerin, polyethylene glycol, and an acid.

Example Ex36: An aerosol-generating system according to Example Ex33, Ex34 or Ex35 in combination with Example Ex5, Ex6 or Ex7, further comprising a third liquid storage compartment in fluid communication with the third region of the piezoelectric transducer.

Example Ex37: An aerosol-generating system according to Example Ex36, further comprising a third liquid aerosol-forming substrate contained within the third liquid storage compartment.

Example Ex38: An aerosol-generating system according to Example Ex37, wherein the third liquid aerosol-forming substrate comprises at least one of nicotine, glycerin, polyethylene glycol, and an acid.

Example Ex39: An aerosol-generating system according to Example Ex36, Ex37 or Ex38 in combination with Example Ex8, 9 or 10, further comprising a fourth liquid storage compartment in fluid communication with the fourth region of the piezoelectric transducer.

Example Ex40: An aerosol-generating system according to Example Ex39, further comprising a fourth liquid aerosol-forming substrate contained within the fourth liquid storage compartment.

Example Ex41: An aerosol-generating system according to Example Ex40, wherein the fourth liquid aerosol-forming substrate comprises at least one of nicotine, glycerin, polyethylene glycol, and an acid.

Example Ex42: An aerosol-generating system according to Example Ex39, Ex40 or Ex41 in combination with Example Ex11, Ex12 or Ex13, further comprising a fifth liquid storage compartment in fluid communication with the fifth region of the piezoelectric transducer.

Example Ex43: An aerosol-generating system according to Example Ex42, further comprising a fifth liquid aerosol-forming substrate contained within the fifth liquid storage compartment.

Example Ex44: An aerosol-generating system according to Example Ex43, wherein the fifth liquid aerosol-forming substrate comprises at least one of nicotine, glycerin, polyethylene glycol, and an acid.

Embodiments of the present disclosure will now be described, by way of example only, with reference to the accompanying drawings, in which:

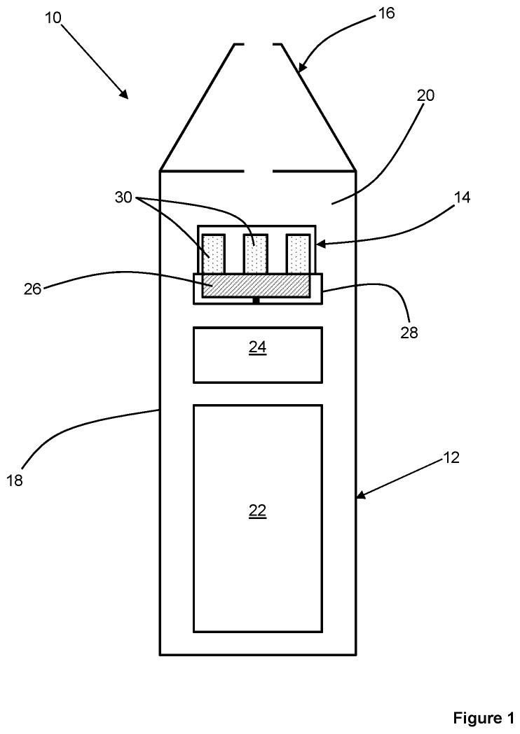

FIG. 1 shows a cross-sectional view of an aerosol-generating system in accordance with an embodiment of the present invention;

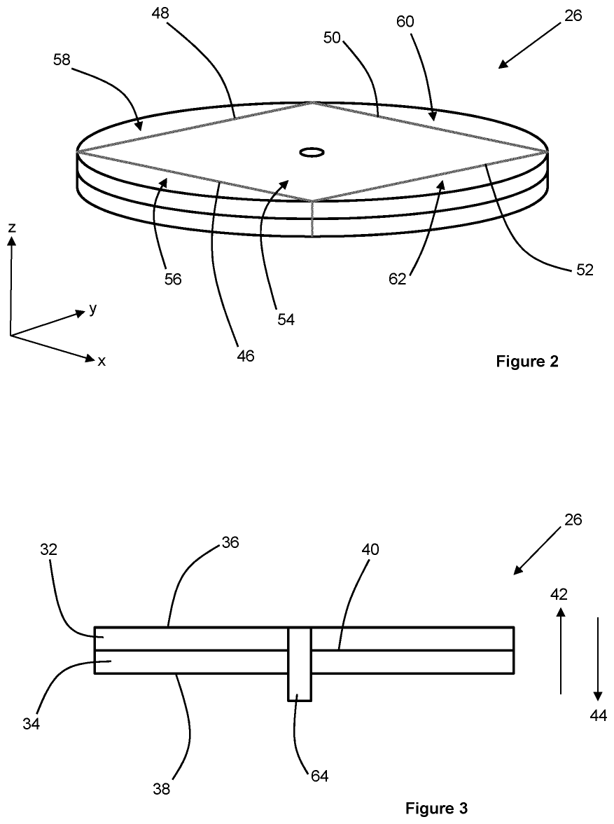

FIG. 2 shows a perspective view of the piezoelectric transducer of the aerosol-generating system of FIG. 1;

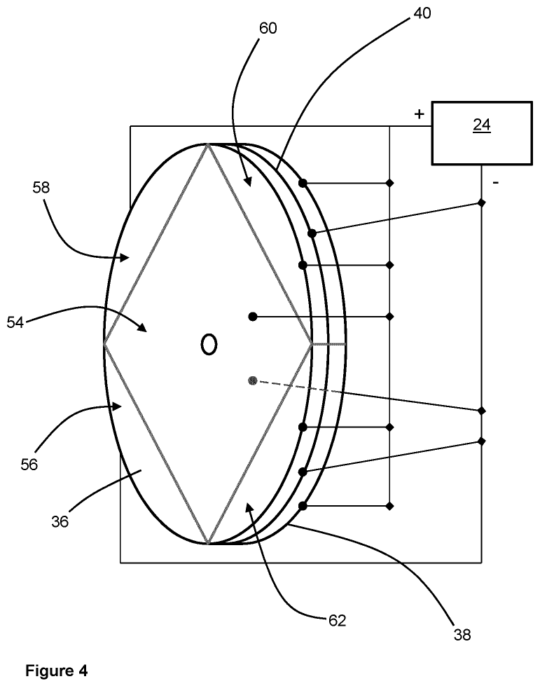

FIG. 3 shows a cross-sectional view of the piezoelectric transducer of FIG. 2;

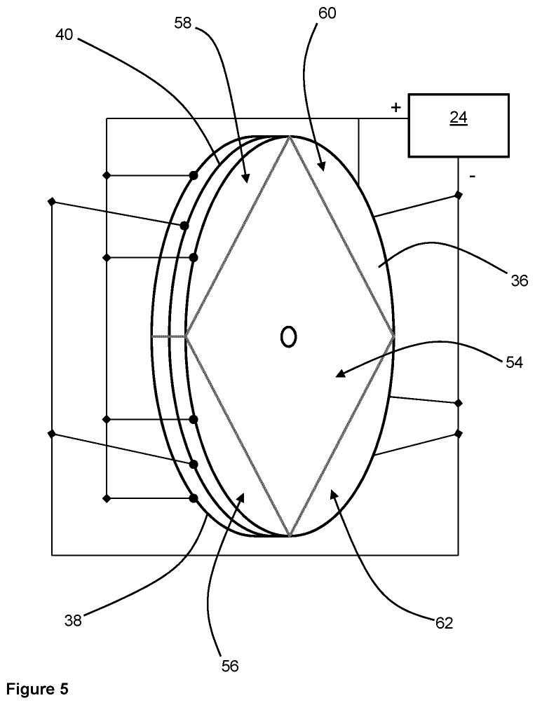

FIG. 4 shows a first perspective view of the piezoelectric transducer of FIG. 2 illustrating the electrical connection to the controller; and

FIG. 5 shows a second perspective view of the piezoelectric transducer of FIG. 2 further illustrating the electrical connection to the controller.

FIG. 1 shows an aerosol-generating system 10 according to an embodiment of the present invention. The aerosol-generating system 10 comprises an aerosol-generating device 12, a cartridge 14 and a mouthpiece 16. The aerosol-generating device 12 comprises a device housing 18 defining a cavity 20 for receiving the cartridge 14. The mouthpiece 16 is detachable from an end of the device housing 18 to allow insertion of the cartridge 14 into the cavity 20.

The aerosol-generating device 12 further comprises a power supply 22 comprising a battery, a controller 24, and a piezoelectric transducer 26 positioned within an aerosol-generator housing 28. As will be further described herein, the controller 24 is configured to supply power from the power supply 22 to the piezoelectric transducer 26 to generate a plurality of oscillating potential differences at different regions of the piezoelectric transducer 26.

The cartridge 14 comprises a plurality of liquid storage compartments 30, each storage compartment 30 containing a liquid aerosol-forming substrate in fluid communication with a region of the piezoelectric transducer 26.

FIGS. 2 and 3 show the piezoelectric transducer 26 in further detail. The piezoelectric transducer 26 has a substantially planar elliptical shape extending in an x-y plane. The piezoelectric transducer 26 has a thickness extending in a z-direction orthogonal to the x-y plane.

The piezoelectric transducer 26 comprises a first layer of piezoelectric material 32 and a second layer of piezoelectric material 34, the first layer of piezoelectric material 32 overlaying the second layer of piezoelectric material 34. A surface of the first layer of piezoelectric material 32 forms a first surface 36 of the piezoelectric transducer 26. During use, liquid aerosol-forming substrate from the liquid storage compartments 30 of the cartridge 14 is aerosolised at the first surface 36 of the piezoelectric transducer 26. A surface of the second layer of piezoelectric material 34 forms a second surface 38 of the piezoelectric transducer 26. The first layer of piezoelectric material 32 contacts the second layer of piezoelectric material 34 at an interface 40 between the first layer of piezoelectric material 32 and the second layer of piezoelectric material 34.

The first layer of piezoelectric material 32 has a substantially planar shape and is polarised in a first direction 42 orthogonal to the substantially planar shape. The second layer of piezoelectric material 34 has a substantially planar shape and is polarised in a second direction 44 orthogonal to the substantially planar shape. The first direction 42 is opposite to the second direction 44.

The piezoelectric transducer 26 comprises a plurality of grooves within the first layer of piezoelectric material 32 and the second layer of piezoelectric material 34, each of the grooves containing an electrically insulating material. The plurality of grooves divides the piezoelectric transducer 26 into a number of electrically separate regions that may be activated or driven independently of each other. Advantageously, separately driving each region facilitates driving each region in a manner that is suited to a particular liquid aerosol-generating substrate. For example, different regions may be driven with at least one of a different vibrational mode and a different frequency depending on the particular liquid aerosol-forming substrate being aerosolised by each region.

In the embodiments shown in FIG. 2 the piezoelectric transducer 26 comprises a first groove 46, a second groove 48, a third groove 50 and a fourth groove 52 that divide the piezoelectric transducer 26 into a first region 54, a second region 56, a third region 58, a fourth region 60 and a fifth region 62. The first region 54 has a rhombus shape and the second region 56, the third region 58, the fourth region 60 and the fifth region 62 each have the same size and shape. The skilled person will appreciate that it is possible to vary the number of grooves, the number of regions and the size and shape of the different regions within the scope of the present invention.

The piezoelectric transducer 26 is secured to the aerosol-generator housing 28 only by a securing pin 64 extending through the centre of the piezoelectric transducer 26 in the first region 54.

The controller 24 is configured to supply power from the power supply 22 to the piezoelectric transducer 26 to generator an oscillating potential difference in each of the first region 54, the second region 56, the third region 58, the fourth region 60 and the fifth region 62. The oscillating potential difference generated in each region results in vibration of the first layer of piezoelectric material 32 and the second layer of piezoelectric material 34, which atomises the liquid aerosol-forming substrate from the liquid storage compartments 30 of the cartridge 14. FIGS. 4 and 5 shows the electrical connection to the piezoelectric transducer 26.

In the first region 54 the controller 24 is configured to supply power to the piezoelectric transducer 26 to generate a first oscillating potential difference in the first region 54 between the first surface 36 of the piezoelectric transducer 26 and the second surface 38 of the piezoelectric transducer 26. The combination of the first region 54 being secured to the aerosol-generator housing 28 and the oscillating potential difference between the first surface 36 and the second surface 38 results in a planar vibration of the piezoelectric transducer 26 along the z-axis in the first region 54.

In each of the second region 56, the third region 58, the fourth region 60 and the fifth region 62, the controller 24 is configured to supply power to the piezoelectric transducer 26 to generating oscillating potential differences between the interface 40 and each of the first surface 36 and the second surface 38, which results in a bending vibrational mode of the piezoelectric transducer 26 in each region about a bending axis extending in the x-y plane.

1.-18. (canceled)

19. An aerosol-generating system, comprising:
an aerosol-generator housing; and
a piezoelectric transducer having an elliptical shape and comprising a first region and a second region, wherein the second region is electrically isolated from the first region,
wherein the piezoelectric transducer is secured to the aerosol-generator housing at a single attachment point positioned only within the first region.

20. The aerosol-generating system according to claim 19, wherein the attachment point is positioned at a centre of the piezoelectric transducer.

21. The aerosol-generating system according to claim 19, wherein the second region extends between the first region and an edge of the piezoelectric transducer.

22. The aerosol-generating system according to claim 19,
wherein the piezoelectric transducer further comprises a first groove in a surface of the piezoelectric transducer and an electrically insulating material positioned within the first groove, and
wherein the first groove defines a boundary between the first region and the second region.

23. The aerosol-generating system according to claim 19, wherein the first region has a rhombus shape.

24. The aerosol-generating system according to claim 19,
wherein the piezoelectric transducer further comprises a first layer of piezoelectric material and a second layer of piezoelectric material, and
wherein the first layer overlies the second layer.

25. The aerosol-generating system according to claim 24,
wherein the first layer of piezoelectric material is polarised in a first direction,
wherein the second layer of piezoelectric material is polarised in a second direction, and
wherein the first direction is opposite to the second direction.

26. The aerosol-generating system according to claim 25,
wherein the first layer of piezoelectric material has a planar shape, and
wherein the first direction is orthogonal to the planar shape of the first layer of piezoelectric material.

27. The aerosol-generating system according to claim 25,
wherein the second layer of piezoelectric material has a planar shape, and
wherein the second direction is orthogonal to the planar shape of the second layer of piezoelectric material.

28. The aerosol-generating system according to claim 24,
wherein a surface of the first layer of piezoelectric material forms a first surface of the piezoelectric transducer,
wherein a surface of the second layer of piezoelectric material forms a second surface of the piezoelectric transducer opposite the first surface, and
wherein the first layer of piezoelectric material contacts the second layer of piezoelectric material at an interface between the first layer of piezoelectric material and the second layer of piezoelectric material.

29. The aerosol-generating system according to claim 19, further comprising:
a power supply; and
a controller configured to supply power from the power supply to the piezoelectric transducer.

30. The aerosol-generating system according to claim 28, further comprising:
a power supply; and
a controller configured to
supply power from the power supply to the piezoelectric transducer, and
supply power to the piezoelectric transducer to generate a first oscillating potential difference in the first region between the first surface of the piezoelectric transducer and the second surface of the piezoelectric transducer.

31. The aerosol-generating system according to claim 30, wherein the controller is further configured to supply power to the piezoelectric transducer to generate a second oscillating potential difference in the second region between the first surface of the piezoelectric transducer and the interface between the first layer of piezoelectric material and the second layer of piezoelectric material.

32. The aerosol-generating system according to claim 31, wherein the controller is further configured to supply power to the piezoelectric transducer to generate a third oscillating potential difference in the second region between the second surface of the piezoelectric transducer and the interface between the first layer of piezoelectric material and the second layer of piezoelectric material.

33. The aerosol-generating system according to claim 19, further comprising a first liquid storage compartment in fluid communication with the first region of the piezoelectric transducer.

34. The aerosol-generating system according to claim 33, further comprising a first liquid aerosol-forming substrate contained within the first liquid storage compartment.

35. The aerosol-generating system according to claim 33, further comprising a second liquid storage compartment in fluid communication with the second region of the piezoelectric transducer.

36. The aerosol-generating system according to claim 35, further comprising a second liquid aerosol-forming substrate contained within the second liquid storage compartment.
